(19) United States
(12) Patent Application Publication
(10) Pub. No.: US 2008/0100051 A1
(43) Pub. Date: May 1, 2008

(54) SEAT BELT ARRANGEMENT FOR CHILD OCCUPANTS OF A VEHICLE

(75) Inventors: John Bell, Carlisle (GB); Martyn Palliser, Carlisle (GB); George Gordon Milton Smith, Dumfries and Galloway (GB)

Correspondence Address: KEY SAFETY SYSTEMS, INC.;PATENT DEPARTMENT, 5300 ALLEN K BREED HIGHWAY, LAKELAND, FL, 33811-1130, US

(73) Assignee: Key Safety Systems, Inc., Sterling Heights, MI (US)

(21) Appl. No.: 11/687,040

(22) Filed: Mar. 16, 2007

(30) Foreign Application Priority Data
Oct. 30, 2006 (EP) 06123207.0

(51) Int. Cl. B60R 22/20

(52) U.S. Cl. 280/801.1

(57) ABSTRACT

A vehicle occupant safety restraint provides a child safety restraint for the three to fourteen year old age range. It can be used with or without a booster cushion or booster seat and would therefore be particularly suitable for minibuses so that the safety belt can still be used by adult passengers. A vertically extending strap is adapted to be located in a generally vertical position against a seat back. A seat belt webbing is attached to a tongue adapted to be located in a buckle mechanism fixed to a load-bearing part of the vehicle. An adjustable webbing guide connects the vertically extending strap to the seat belt webbing. The webbing guide is positively locked to the vertically extending strap at any one of a plurality of selectable locations on the vertically extending strap.

### FIELD OF THE INVENTION

The present invention relates to a vehicle occupant safety restraint, particularly a seat belt that is suitable for restraining child seat occupants of a vehicle, but which can also be used for restraining adults.

### BACKGROUND OF THE INVENTION

A conventional seat belt comprises a length of seat belt webbing connected at three points to load-bearing parts of a vehicle. The webbing is arranged to have a lap portion that passes laterally across the hips of the seat occupant, and a torso portion that passes diagonally across the torso of the seat occupant from one hip to the opposite shoulder.

Typically one end of the webbing is attached to a sill anchor that is bolted to a load-bearing longitudinal structural member on one side of the seat, usually between the seat and an adjacent door. The lap and torso portions join at a buckle mechanism on the opposite side of the seat and the shoulder end of the webbing is attached to a seat belt retractor mounted to a load-bearing part of the vehicle, for example a side pillar or sill, or directly to a load-bearing seat, optionally via a webbing guide.

The seat belt retractor increases comfort for the seat occupant restrained by the seat belt since it allows the webbing to pay out under relatively low loads to enable limited movement of the restrained seat occupant, for example to reach in-car entertainment controls or storage compartments. The seat belt retractor is biased to keep the webbing relatively taut about the seat occupant and a locking element locks the seat belt retractor against webbing payout in the event an acceleration sensor senses rapid acceleration or deceleration indicative of a crash.

The belt webbing is fastened to the buckle mechanism by a buckle tongue that is attached to the webbing such that it can slide so that the proportions of webbing making up the lap and torso portions can easily be varied to suit the size and shape of the seat occupant.

Conventional seat belt restraints of this sort tend to be unsuitable for vehicle seat occupants of shorter than average stature, particularly for children, because the shoulder fastening point is fixed to accommodate an average person and is fixed at or above the height of the back of the seat. This is particularly so in rear seat safety restraints.

The torso portion of the seat belt tends to be badly positioned for a child or short person and usually passes too close or adjacent to the child's neck. Because the child does not fit into the adult seat belt properly the child's shoulder can roll out of the seat belt during a crash effectively making the seat belt a two-point lap belt only. This is dangerous because the lap portion alone will then take more force in a crash and will be more likely to inflict injuries than when a torso belt section is combined. In addition there is a danger of the child sliding under the lap portion; this is known as submarining.

### DISCUSSION OF THE PRIOR ART

It is well known that children feel uncomfortable with adult seat belt restraints and often position the torso portion behind their back to reduce discomfort. A solution to this problem is exemplified in a product known as “The Generation Belt” which provides an additional strap which is fastened taut in a generally vertical orientation to the back of the seat. A shoulder support for the seat belt is attached in a manner such that it can slide to the vertically extending strap so that its vertical position can be varied. However, the shoulder support is not retained in the desired position by anything other than friction and under high crash loads it may slide upwardly putting the shoulder support in an unsuitable and dangerous position again. This belt was designed for comfort rather than safety and does not comply with the latest safety regulations of which at least one is ECE 44/03.

### SUMMARY OF THE INVENTION

According to one aspect of the present invention there is provided a vehicle occupant safety restraint comprising: a vertically extending strap adapted to be located in a generally vertical position against a seat back; a seat belt webbing which is attached to a tongue adapted to be located in a buckle mechanism fixed to a load-bearing part of the vehicle; an adjustable webbing guide for connecting the vertically extending strap to seat belt webbing; and means for positively locking the webbing guide to the vertically extending strap at any one of a plurality of selectable locations on the vertically extending strap.

According to an alternative embodiment of the invention the adjustable webbing guide comprises a web clamp arranged to positively engage the vertically extending strap to lock the adjustable webbing guide at said one of the selectable locations. Preferably the web clamp comprises a jaw having a toothed surface and a frame, the jaw being pivotally mounted and spring loaded so that the toothed surface is normally tensioned towards the frame thereby providing means for clamping the vertically extending strap. Advantageously the web clamp is releasable from clamping the vertically extending strap by means of a push button connected to the jaw.

### BRIEF DESCRIPTION OF THE DRAWINGS

FIG. 1 is a schematic view of a small child restrained in a vehicle seat by a conventional seat belt.

FIG. 2 is a schematic view of a small child restrained in a vehicle seat by a seat belt according to the present invention.

FIG. 3 is a schematic view of a larger child restrained in a vehicle seat by a seat belt system according to the present invention.

FIG. 4 is a schematic view of an adult restrained in a vehicle seat by a seat belt system according to the present invention.

FIG. 5 is a schematic view showing the seat belt system of FIGS. 2, 3 and 4 in more detail.

FIG. 6 is a perspective view of part of the seat belt system of FIGS. 2, 3, 4 and 5.

FIG. 7 is a front view of the part shown in FIG. 6.

FIG. 8 is a side view of the seat belt of FIGS. 2 to 7 attached to a seat.

FIG. 9 is a perspective view illustrating more detail of one embodiment of an adjustable webbing guide forming part of the seat belt system of FIGS. 2 to 8.

FIG. 10 is a cross-sectional view of the adjustable webbing guide of FIG. 9 in a released configuration.

FIG. 11 is a cross-sectional view of the adjustable webbing guide of FIG. 9 in a locked configuration.

FIG. 12 is a perspective view of a second embodiment of an adjustable webbing guide of the seat belt system of FIGS. 2 to 8.

FIG. 13 is an exploded perspective view of the embodiment of FIG. 12.

FIG. 14 is a cross-sectional view of the adjustable webbing guide shown in FIGS. 12 and 13 in a released configuration.

FIG. 15 is a cross-sectional view of the adjustable webbing guide of FIGS. 12 and 13 in a locked configuration.

FIG. 16 is a side view of the adjustable webbing guide of FIGS. 12 and 13 in the locked configuration.

### DETAILED DESCRIPTION OF THE INVENTION

FIG. 1 shows a conventional seat belt when used for a child 1 sitting in a vehicle seat 2. The seat belt comprises a lap portion 3 and a torso portion 4. The seat belt is attached to load-bearing parts of the vehicle at three points: a lower fixing point 5 at one side of the seat, a buckle fixing point 6 at the opposite side of the seat and an upper fixing point 7 at the top of the seat back. In FIG. 1 the conventional seat belt places the torso portion 4 in an unsuitable position for a child 1, since it would pass across the child's head 8 or neck.

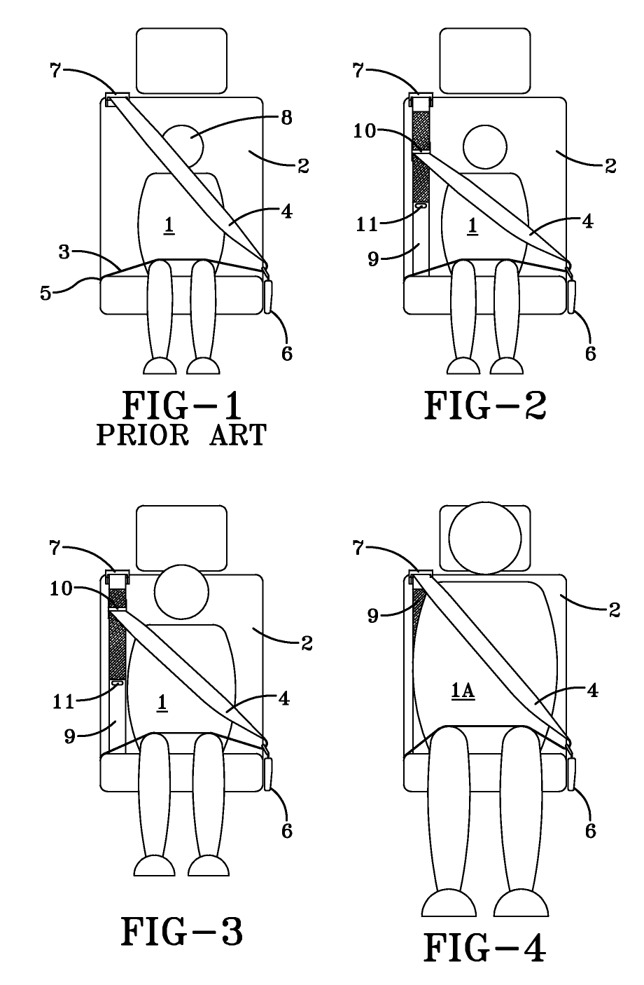

In FIG. 2 a seat belt system according to the present invention is illustrated. The inventive seat belt system comprises a generally vertically extending strap 9 attached to the seat 2 at the upper fixing point 7 and also at a lower point on the seat back, so that it lies in a generally vertical orientation against the backrest of the seat 2. An adjustable webbing guide 10 connects the torso portion 4 of the seat belt to the vertically extending strap 9 so as to lower the effective shoulder attachment point to a position that ensures that the torso portion 4 of the seat belt is more correctly and safely positioned to extend from the hip to the opposite shoulder of a child 1 occupying the vehicle seat 2.

A stop 11, which may be in the form of a raised plastic button or protrusion on the vertically extending strap 9, prevents further movement of the adjustable guide 10 below this point on the strap 9. The stop serves as an indicator to the minimum size of the seat occupant that can use the restraint. If the adjuster is moved to the lowest position and the seat occupant's shoulder is below this level then the seat occupant is too small for the restraint and should use an appropriate child restraint. The stop 11 will normally be positioned at a point that meets safety regulations or legal requirements for allowable seat occupant height. The stop has a thickness which is greater than the width of the first slot of the adjustable webbing guide to prevent movement of the adjustable webbing guide on the vertically extending strap beyond the stop.

In FIG. 3 the inventive seat belt system is shown with a slightly larger child 1 occupying the seat 2. The adjustable webbing guide 10 is mounted at a higher point on the vertically extending strap 9, again ensuring that the torso portion 4 of the seat belt suitably passes from the hip of the seat occupant to the opposite shoulder as illustrated.

In FIG. 4 an adult 1A occupies the seat 2 and in this case the adjustable webbing guide 10 is either removed altogether from the vertically extending strap 9 or is positioned at the top of the vertically extending strap 9 so that the seat belt can be used as normal.

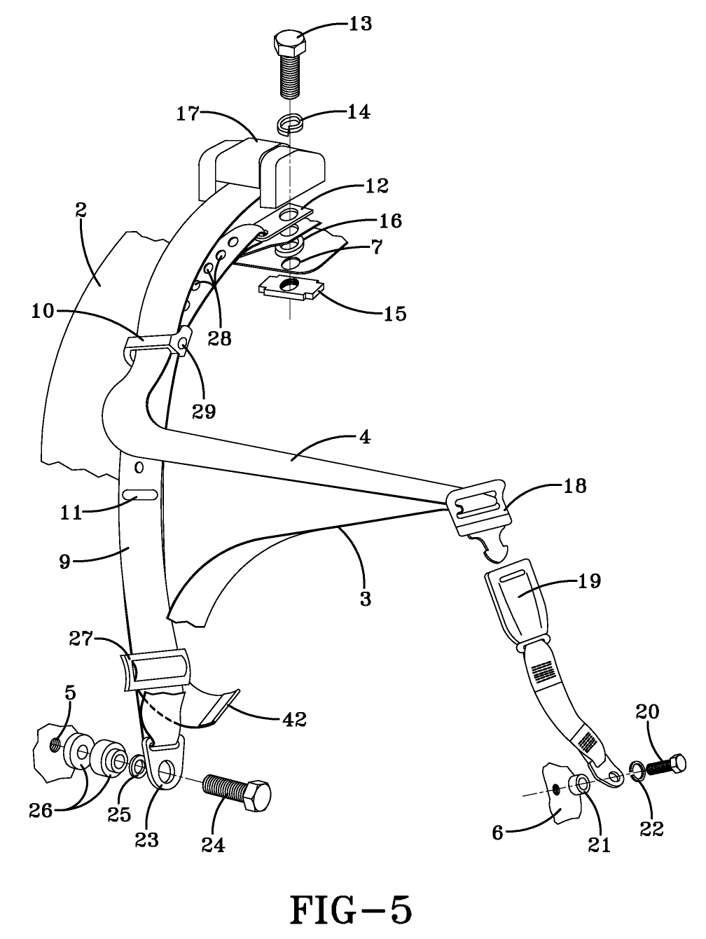

FIG. 5 shows the inventive seat belt system in more detail in an exploded view. At the upper fixing point 7, the vertically extending strap 9 is attached directly in the region of the top of the seat 2 by a bracket 12 fastened to a load-bearing vehicle part such as a parcel shelf or a load-bearing part of the seat 2 and is held in place by a retractor fixing bolt 13 passing through a washer 14 and into a tapped anchor plate 15 via a spacer 16. The retractor fixing bolt 13 also holds in place a seat belt retractor 17. One end of the torso portion 4 of the seat belt webbing is attached to the seat belt retractor 17. The torso portion 4 of the seat belt webbing passes through the adjustable webbing guide 10 and is attached to a buckle tongue 18 that fastens into a buckle mechanism 19. The buckle mechanism 19 is fixed, with bolt 20, optional spacer 21 and washer 22 to an anchor point 6 which may be in the vehicle body floor or another load-bearing vehicle part such as a pillar. The other end of the lap portion 3 of the seat belt is attached to a lower fixing point 5 that may be an anchor point in the door sill or the vehicle body. The lower fixing point 5 holds not only anchors the other end of the lap portion 3 of the seat belt but also the bottom end of the vertically extending strap 9 via a common fixing bracket 23 fixed at the anchor point 5 by bolt 24 using a wave washer 25 and two optional spacers 26. The vertically extending strap 9 can be made taught between the fixing points 5, 7 by an adjuster 27 and the loose end 42 of the vertically extending strap 9 will typically be tucked under the seat cushion.

The adjustable webbing guide 10 is located on the vertically extending strap 9 by engagement of a projection on the underside of the webbing guide 10 with an appropriate hole 28 in the vertically extending strap 9. The projection can be disengaged from one end of a hole 28 via a push button 29 on one or both sides of the adjustable webbing guide 10. The lower limit of the position of the webbing guide 10 is determined by the stop 11.

FIG. 6 shows a section of the vertically extending strap 9 in more detail without the seat belt webbing being shown. Like parts are numbered accordingly. Thus the adjustable webbing guide 10 is engageable with any one of the holes 28 via a projection (not shown) that is operated by at least one push button 29. A stop 11 limits the downward movement of the adjustable webbing guide 10.

FIG. 7 shows a preferred embodiment of the vertically extending strap 9 on which zones are clearly marked to define approximate regions of the vertically extending strap 9 in which the adjustable webbing guide 10 must be located to ensure the correct shoulder height for different age groups. In FIG. 7 it can be seen that the adjustable webbing guide 10 is positioned in “ZONE 3” which is clearly indicated as a region that would be suitable for children up to fourteen years of age. Other indicia or instructions can be incorporated into the vertically extending strap 9. For example in FIG. 7 the instruction “adjust level in-line with shoulder” is included.

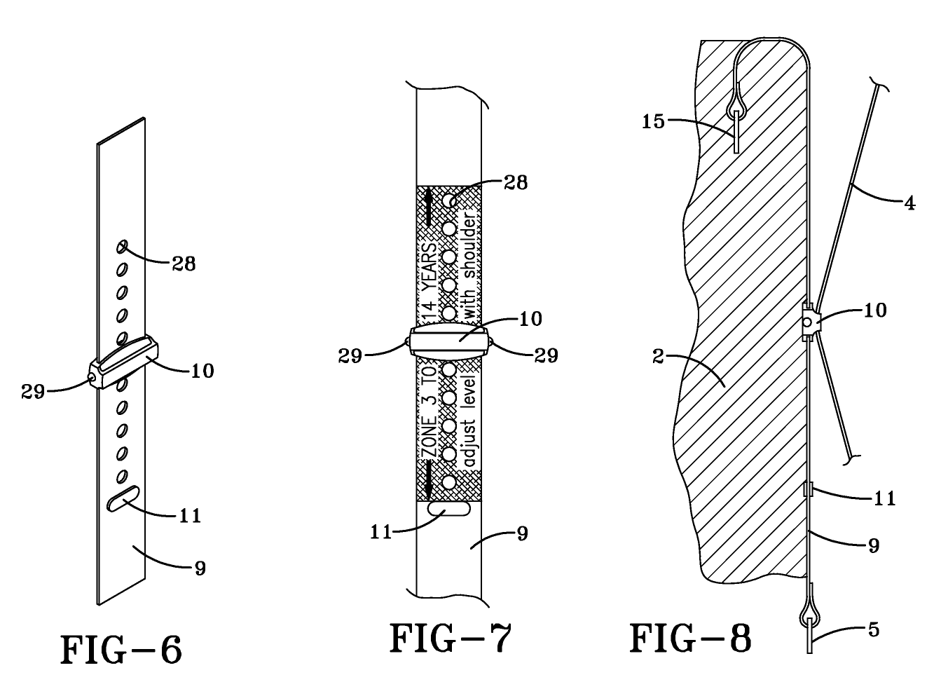

FIG. 8 is a side cross sectional view of part of the seat belt system of the invention. Again like parts are denoted by like reference numbers. The vertically extending strap 9 is anchored at its upper end in the seat back 2 via anchor plate 15 and at its lower end by the anchor point 5 to a load-bearing part of a vehicle. The vertically extending strap 9 passes through a rear slot in the webbing guide 10 and the torso portion 4 of the seat belt passes through a front slot.

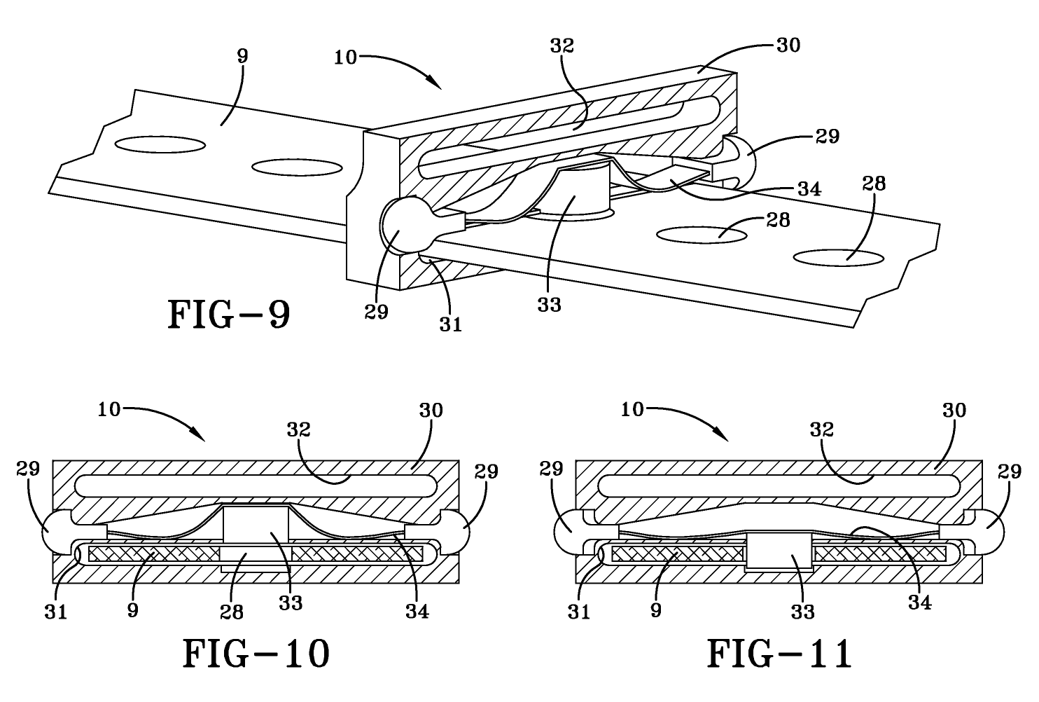

FIGS. 9, 10 and 11 show an embodiment in which the webbing guide 10 comprises a housing 30 with two slots, a first slot 31 through which the vertically extending strap 9 passes, and a second slot 32 through which the torso portion 4 of the seat belt webbing passes. The adjustable webbing guide 10 is held in position relative to the vertically extending strap 9 by a retractable projection 33 that protrudes into and preferably through one of the holes 28 in the vertically extending strap 9. The projection 33 is attached to a leaf spring 34 that urges the projection 33 to normally protrude through the hole 28. One of two push buttons 29 is arranged on each end of the leaf spring 34. When both push buttons 29 are pressed towards each other the projection 33 moves out of the hole 28 clear of the vertically extending strap 9, enabling the adjustable webbing guide 10 to be moved along the length of the vertically extending strap 9. FIG. 10 is a cross-sectional view of the adjustable webbing guide of FIG. 9 in a released configuration. When the push buttons 29 are released the projection 33 is pushed by the force of the spring 34 towards the vertically extending strap 9. If the projection 33 is aligned with a hole 28 then the projection 33 will protrude through the hole 28, thereby locking the adjustable webbing guide 10 in position, as shown in FIG. 11.

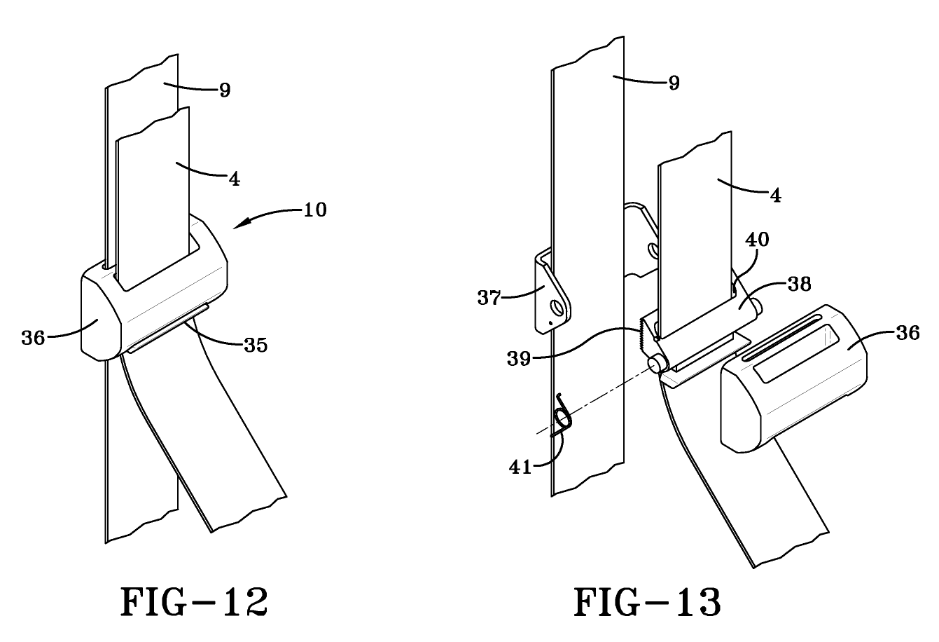

In FIGS. 12 through 16 show a further embodiment of the adjustable webbing guide 10 of the seat belt that uses web clamping to hold the adjustable webbing guide 10 in position on the vertically extending strap 9. The principal of web clamping is known in the art of seat belt retractor technology in combination with seat belt retractors.

The adjustable webbing guide 10 comprises a cover 36, a frame 37 and a jaw 38. The jaw 38 includes a push button 35, a toothed surface 39 and a webbing slot 40 through which the torso portion 4 of the seat belt passes. The jaw 38 is pivotally mounted to the frame 37 and spring loaded with a torsion spring 41, as shown in FIG. 16, so that the toothed surface 39 is normally tensioned towards the frame 37. The vertically extending strap 9 is located between the frame 37 and the toothed surface 39 of the jaw 38 so that the adjustable webbing guide 10 is normally held in position relative to the vertically extending strap 9 by the clamping force between the jaw 38 and the frame 37 on the vertically extending strap 9.

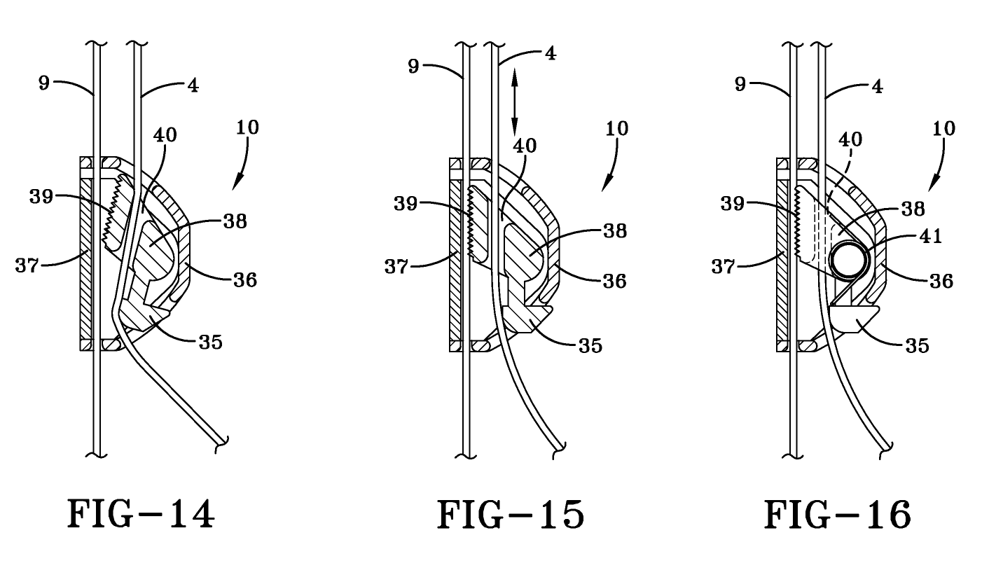

In FIG. 14 the adjustable webbing guide 10 of FIGS. 12 and 13 is shown from the side in a cross-section view, with pressure being applied to the push button 35 of the jaw 38, such that the jaw 38 is pivoted away from the frame 37 toward the cover 36 and there is no clamping force applied to the vertically extending strap 9, allowing the adjustable webbing guide 10 to move longitudinally with respect to the vertically extending strap 9.

FIGS. 15 and 16 show the adjustable webbing guide 10 of FIGS. 12 and 13 when no pressure is applied to the push button 35. The torsion spring 41 shown in FIG. 16 provides the clamping force between the toothed surface 39 of the jaw 38 and the frame 37 so that the adjustable webbing guide 10 biased toward the vertically extending strap 9 and the jaw 38 is pivoted toward the frame 37 to clamp the vertically extending strap 9 and secure the adjustable webbing guide 10 in position.

Typically this invention provides a child safety restraint for the three to fourteen year old age range. It can be used with or without a booster cushion or booster seat and would therefore be particularly suitable for minibuses so that they can still be used by adult passengers.

The way in which the adjustable webbing guide 10 is locked onto the vertically extending strap 9 could take other forms, such as for example a toggle clamp in place of the holes punched through the webbing as illustrated. A toggle clamp is an over center linkage mechanism. When the mechanism is moved from its unlocked position there is a lot of movement but low force. However, when the mechanism nears the locked or clamped position, and the link is nearing “top dead center”, for the same amount of lever movement there is significantly less movement of the clamp and the load is much greater.

It is understood that the invention is not limited to the particular construction and arrangement of parts herein illustrated and described, but embraces all such modified forms thereof as come within the scope of the following claims.

1. A vehicle occupant safety restraint comprising:
a strap adapted to be located in a generally vertical position against a seat back;
a seat belt webbing that is attached to a tongue adapted to be located in a buckle mechanism fixed to a load-bearing part of the vehicle;
an adjustable webbing guide for connecting the generally vertically extending strap to seat belt webbing; and
a means for positively locking the webbing guide to the vertically extending strap at any one of a plurality of selectable locations on the vertically extending strap.

2. The vehicle occupant safety restraint according to claim 1 wherein the adjustable webbing guide has a first slot to accommodate the vertically extending strap and a second slot to accommodate the seat belt webbing.

3. The vehicle occupant safety restraint according to claim 1 wherein a first end of the vertically extending strap has a first end attached to the seat back at an upper fixing point and a second end of the vertically extending strap is attached at a lower fixing point.

4. The vehicle occupant safety restraint according to claim 2 wherein a first end of the vertically extending strap is attached to the seat back at an upper fixing point and a second end of the vertically extending strap is attached at a lower fixing point.

5. The vehicle occupant safety restraint according to claim 1 wherein the vertically extending strap comprises means to define a lower limit for movement of the adjustable webbing guide on the vertically extending strap.

6. The vehicle occupant safety restraint according to claim 5 wherein the lower limit defining means is a stop comprising a protrusion located on the vertically extending strap.

7. The vehicle occupant safety restraint according to claim 6 wherein the protrusion has a thickness which is greater than the width of the first slot of the adjustable webbing guide to prevent movement of the adjustable webbing guide on the vertically extending strap beyond the stop.

8. The vehicle occupant safety restraint according claim 1 wherein the vertically extending strap includes markings defining regions on the vertically extending strap in which the adjustable webbing guide should be located indicative of the correct positioning of the adjustable webbing guide in dependence upon the age or height of a user of the safety restraint.

9. The vehicle occupant safety restraint according to claim 1 wherein the vertically extending strap comprises a plurality of holes therethrough spaced along its length, and the adjustable webbing guide comprises a retractable projection sized such that the projection can be inserted through any one of the holes to lock the adjustable webbing guide to the vertically extending strap.

10. The vehicle occupant safety restraint according to claim 9 wherein the retractable projection is retractable by means at least one push button.

11. The vehicle occupant safety restraint according to claim 10 wherein the retractable projection is biased to an unretracted position.

12. The vehicle occupant safety restraint according to claim 11 wherein the retractable projection is biased to an unretracted position by a leaf spring.

13. The vehicle occupant safety restraint according to claim 1 wherein the adjustable webbing guide comprises a web clamp adapted to positively engage the vertically extending strap to lock the adjustable webbing guide to the vertically extending strap.

14. The vehicle occupant safety restraint according to claim 13 wherein the web clamp comprises a jaw, and a frame, wherein the jaw is pivotally mounted and spring loaded so that the jaw is normally tensioned towards the frame exerting a for clamping force on the vertically extending strap between the jaw and the frame.

15. The vehicle occupant safety restraint according to claim 14 wherein the jaw is pivotable away from the frame by means of a push button connected to the jaw, to release the clamping force on the vertically extending strap.

16. The vehicle occupant safety restraint according to claim 14 wherein the jaw comprises a toothed surface facing toward the vertically extending strap.

17. A vehicle occupant safety restraint comprising:
a vertically extending strap adapted to be located against a seat back;
a seat belt webbing that is attached to a tongue adapted to be located in a buckle mechanism fixed to a load-bearing part of the vehicle;
an adjustable webbing guide for connecting the vertically extending strap to seat belt webbing; and
means for defining a location for the adjustable webbing guide on the vertically extending strap.

18. The vehicle occupant safety restraint according to claim 17 wherein the location defining means comprises means for defining a lower limit for the location of the adjustable webbing guide on the vertically extending strap.

19. The vehicle occupant safety restraint according to claim 18 wherein the lower limit defining means is a protrusion located on the vertically extending strap.

20. The vehicle occupant safety restraint according to claim 18 wherein the adjustable webbing guide comprises a first slot to accommodate the vertically extending strap and a second slot to accommodate the seat belt webbing.

21. The vehicle occupant safety restraint according to claim 20 wherein the protrusion has a thickness which is greater than the width of the first slot of the adjustable webbing guide to prevent movement of the adjustable webbing guide on the vertically extending strap beyond the stop.

22. The vehicle occupant safety restraint according to claim 17 wherein the location defining means comprise markings indicating regions on the vertically extending strap indicative of correct locations of the adjustable webbing guide on the vertically extending strap depending upon predetermined conditions.

23. A vehicle occupant safety restraint comprising:
a strap adapted to be located in a generally vertical position against a seat back, a first end of the vertically extending strap being attached to the seat back at an upper fixing point and a second end of the vertically extending strap being attached at a lower fixing point, the vertically extending strap comprises a plurality of holes therethrough;
a seat belt webbing that is attached to a tongue adapted to be located in a buckle mechanism fixed to a load-bearing part of the vehicle;
an adjustable webbing guide for connecting the generally vertically extending strap to seat belt webbing, the adjustable webbing guide having a first slot to accommodate the vertically extending strap and a second slot to accommodate the seat belt webbing, the adjustable webbing guide comprises a retractable projection sized such that the projection can be inserted through any one of the holes to lock the adjustable webbing guide to the vertically extending strap at any one of a plurality of selectable locations on the vertically extending strap.

24. The vehicle occupant safety restraint according to claim 23 wherein the retractable projection is retractable by means at least one push button.

25. The vehicle occupant safety restraint according to claim 23 wherein the retractable projection is biased to an unretracted position.

26. The vehicle occupant safety restraint according to claim 23 wherein the retractable projection is biased to an unretracted position by a leaf spring.

27. A vehicle occupant safety restraint comprising:
a strap adapted to be located in a generally vertical position against a seat back, a first end of the vertically extending strap being attached to the seat back at an upper fixing point and a second end of the vertically extending strap being attached at a lower fixing point;
a seat belt webbing that is attached to a tongue adapted to be located in a buckle mechanism fixed to a load-bearing part of the vehicle;
an adjustable webbing guide for connecting the generally vertically extending strap to seat belt webbing, the adjustable webbing guide having a first slot to accommodate the vertically extending strap and a second slot to accommodate the seat belt webbing, the adjustable webbing guide having a web clamp adapted to positively engage the vertically extending strap to lock the adjustable webbing guide to the vertically extending strap at any one of a plurality of selectable locations on the vertically extending strap, the web clamp comprising a jaw, and a frame, wherein the jaw is pivotally mounted and spring loaded so that the jaw is normally tensioned towards the frame exerting a for clamping force on the vertically extending strap between the jaw and the frame.

28. The vehicle occupant safety restraint according to claim 27 wherein the jaw is pivotable away from the frame by means of a push button connected to the jaw, to release the clamping force on the vertically extending strap.

29. The vehicle occupant safety restraint according to claim 27 wherein the jaw comprises a toothed surface facing toward the vertically extending strap.
